(19) United States
(12) Patent Application Publication
(10) Pub. No.: US 2009/0133227 A1
(43) Pub. Date: May 28, 2009

(54) HANDLE MECHANISM

(75) Inventors: Chih-Chung Yang, Hsin-Chu (TW); His-Chih Sun, Hsin-Chu (TW); Kuo-Wei Li, Hsin-Chu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsin-Chu (TW)

(21) Appl. No.: 12/111,209

(22) Filed: Apr. 29, 2008

(30) Foreign Application Priority Data
Nov. 27, 2007 (TW) 96144989

(51) Int. Cl. B25G 1/04

(52) U.S. Cl. 16/421; 16/429

(57) ABSTRACT

A handle mechanism is adapted to a projector having a case. The handle mechanism has a frame, a rod, a grip, a positioning element, and an elastic element. The frame is connected to the case and has a through hole. The rod penetrates through the through hole and is capable of moving relatively to the frame. The rod has a first end, a second end, an anchor portion at the first end thereof, a first positioning portion, and a second positioning portion. The grip is connected to the second end of the rod, wherein the anchor portions limit a movement range of the grip relative to the rods and the frame. The positioning element is located between the frame and the rod. The elastic element is located between the frame and the positioning element, and forces the positioning element to physically interfere with the first or the second positioning portion.

### CROSS-REFERENCE TO RELATED APPLICATION

This application claims the priority benefit of Taiwan application serial no. 96144989, filed on Nov. 27, 2007. The entirety of the above-mentioned patent application is hereby incorporated by reference herein and made a part of specification.

### BACKGROUND OF THE INVENTION

1. Field of the Invention

The present invention relates to a handle mechanism. More particularly, the present invention relates to a handle mechanism adapted to a projector.

2. Description of Related Art

Presently, size and weight of a projector have been greatly reduced, so that a user may carry the projector through a handle thereon, which avails transportation of the projector. Generally, the handle is directly disposed on the case of the projector.

To provide an enough space between the handle and the case for a hand of the user passing through, the handle is generally designed to protrude out from outline of the case, however, this may influence a whole appearance of the projector. Moreover, such design may also increase the size of the projector.

### SUMMARY OF THE INVENTION

The present invention is directed to a handle mechanism adapted to a projector, which may provide a grip that may be pulled out and pushed back.

An embodiment of the present invention provides a handle mechanism, which is adapted to a projector having a case. The handle mechanism includes a frame, a pair of rods, a grip, a pair of positioning elements, and a pair of elastic elements. The frame is connected to the case and has a pair of through holes. The rods respectively penetrate through the through holes and may be moved relatively to the frame, wherein each of the rods has a first end, a second end, an anchor portion located at the first end thereof, a first positioning portion, and a second positioning portion. The grip is connected to the second ends of the rods, wherein the anchor portions limit a movement range of the grip relative to the frame. The positioning elements are respectively located between the frame and the rods. The elastic elements are respectively located between the frame and the positioning elements, and force the positioning elements to physically interfere with the first positioning portions or the second positioning portions.

Another embodiment of the present invention provides a handle mechanism, which is adapted to a projector having a case. The handle mechanism includes a frame, a rod, a grip, a positioning element, and an elastic element. The frame is connected to the case and has a through hole. The rod penetrates through the through hole and may be moved relatively to the frame, wherein the rod has an anchor portion located at a first end of the rod, a first positioning portion, and a second positioning portion. The grip is connected to a second end of the rod, wherein the anchor portion limits a movement range of the grip relative to the frame. The positioning element is located between the frame and the rod. The elastic element is located between the frame and the positioning element, and forces the positioning element to physically interfere with the first positioning portion or the second positioning portion.

In the embodiments of the present invention, the anchor portion of the rod limits the movement range of the grip relative to the frame, and the positioning portion of the rod, the positioning element and the elastic element may temporarily fix in one of a plurality of positions of the grip relative to the frame.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A is a perspective view illustrating a pushed-back state of a handle mechanism according to an embodiment of the present invention assembled to a case of a projector.

FIG. 1B is a perspective view illustrating a pulled-out state of a handle mechanism assembled to a case of the projector of FIG. 1A.

FIG. 2A is a perspective view illustrating a pushed-back state of the handle mechanism of FIG. 1A.

FIG. 2B is a perspective view illustrating a pulled-out state of the handle mechanism of FIG. 1A.

FIG. 3 is an exploded view of the handle mechanism of FIG. 2A.

FIG. 4 is another exploded view of the handle mechanism of FIG. 2A.

FIG. 5A is a cross-sectional view of a pushed-back state of the handle mechanism of FIG. 2A.

FIG. 5B is a cross-sectional view of a pulled-out state of the handle mechanism of FIG. 2A.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

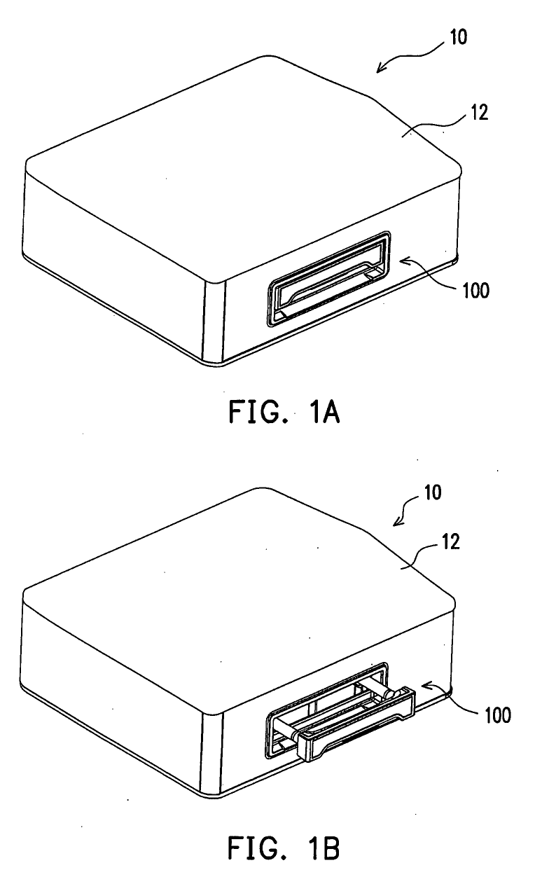

FIG. 1A and FIG. 1B are perspective views illustrating a pulled-out state and a pushed-back state of a handle mechanism according to an embodiment of the present invention assembled to a case of a projector. Referring to FIG. 1A, the handle mechanism 100 is adapted to a projector 10. In the pushed-back state, the handle mechanism 100 does not protrude out from an outline of a case 12 of the projector 10, as shown in FIG. 1A. In the pulled-out state, the handle mechanism 100 protrudes out from the outline of the case 12 of the projector 10, as shown in FIG. 1B.

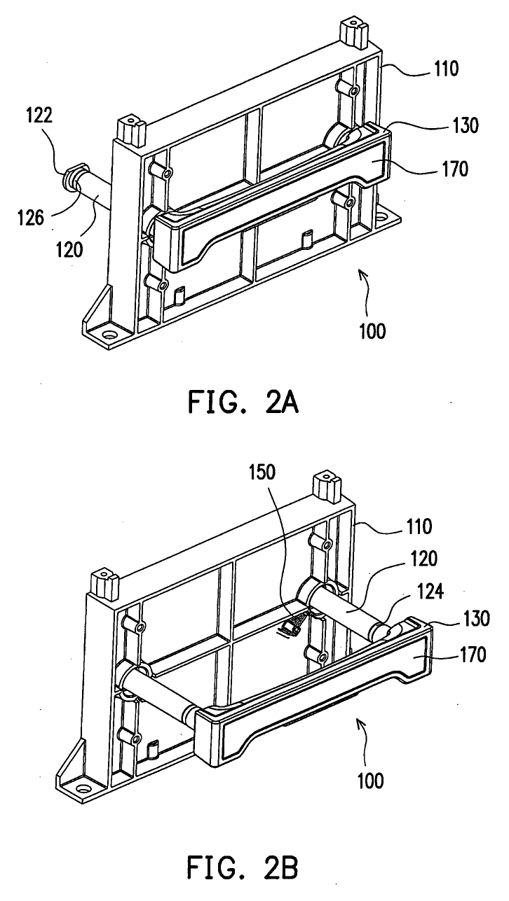

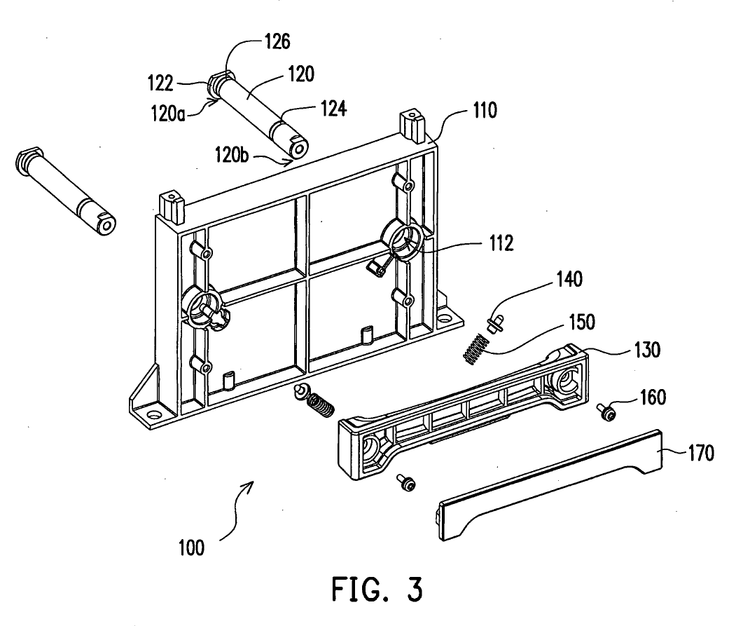

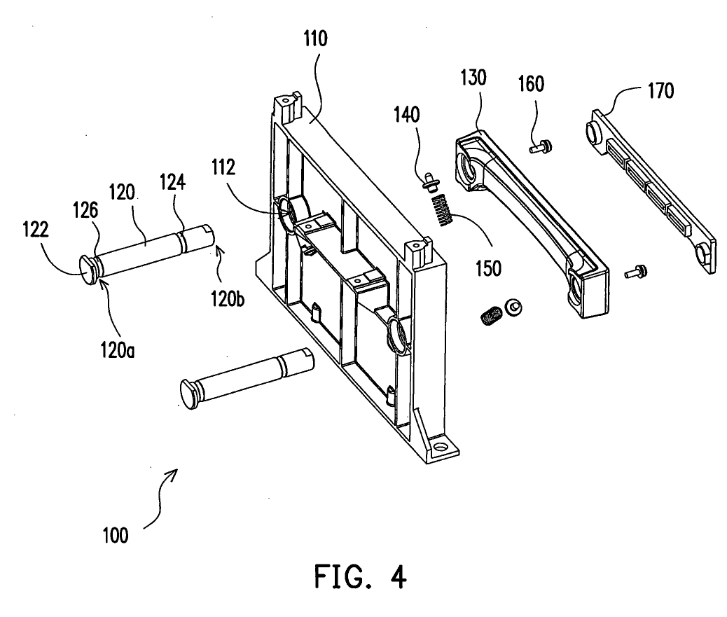

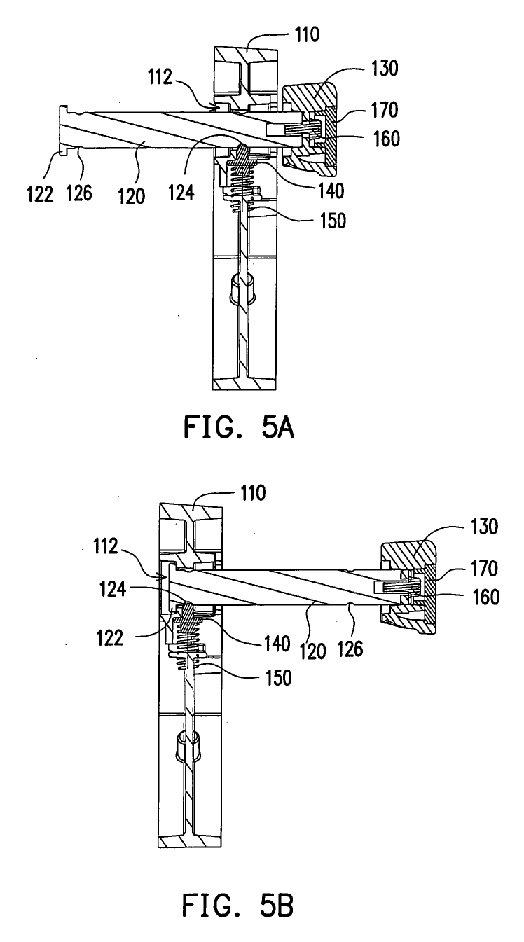

FIG. 2A and FIG. 2B are perspective views illustrating a pulled-out state and a pushed-back state of the handle mechanism of FIG. 1A. FIG. 3 and FIG. 4 are two different exploded views of the handle mechanism of FIG. 2A. FIG. 5A and FIG. 5B are cross-sectional views of a pulled-out state and a pushed-back state of the handle mechanism of FIG. 2A. Referring to FIG. 2A, FIG. 3, FIG. 4 and FIG. 5A, the handle mechanism 100 includes a frame 110, a pair of rods 120 and a grip 130.

The frame 110 is connected to the case 12 and has a pair of through holes 112. The rods 120 respectively penetrate through the through holes 112 and may be moved relatively to the frame 110, wherein each of the rods 120 has an anchor portion 122 located at a first end 120a of the rod 120. The grip 130 is connected to a second end 120b of the rods 120, as shown in FIG. 3 and FIG. 4. In the embodiment of the present embodiment, two ends of the grip 130 are respectively connected to the second ends 120b of the rods 120. Therefore, the anchor portions 122 and the grip 130 may limit a movement range of the rods 120 relative to the frame 110.

To temporarily fix a relative position between the grip 130 and the frame 110 under the pushed-back state shown as FIG. 2A and the pulled-out state shown as FIG. 2B, each rod 120 further includes a first positioning portion 124 and a second positioning portion 126, and the handle mechanism 100 further includes a pair of positioning elements 140 and a pair of elastic elements 150. The positioning elements 140 are respectively located between the frame 110 and the rods 120. The elastic elements 150 are respectively located between the frame 110 and the positioning elements 140, and force the positioning elements 140 to physically interfere with the first positioning portions 124 or the second positioning portions 126, as shown in FIG. 5A and FIG. 5B. In the present embodiment, the elastic elements 150 are spiral springs.

In the present embodiment, the frame 110 is assembled to an inner side of the case 12. However, in another embodiment (not shown), the frame 110 and the case 12 may be integrally formed, namely, the frame 110 may be formed by a part of the case 12.

In the present embodiment, the first positioning portions 124 and the second positioning portions 126 are fitting grooves circularly disposed around the rods 120, and the positioning elements 140 are fitting flanges which may be fitted into the first positioning portions 124 or the second positioning portions 126.

The handle mechanism 100 further includes a pair of fasteners 160, and the fasteners 160 may fix the two ends of the grip 130 to the ends (i.e. the second ends 120b) of the rods 120. In the present embodiment, the fasteners 160 are screws. Moreover, the handle mechanism 100 further includes a decorating sheet 170 attached to the grip 130 for shielding the fasteners 160.

In the present embodiment, the pair of rods is applied so that the grip may be pulled out or pushed back relatively to the frame. However, in another embodiment (not shown), a single rod may be applied, and the grip may also be pulled out or pushed back relatively to the frame.

In summary, in the embodiments of the present invention, the anchor portions of the rods are used for limiting the movement range of the grip relative to the frame, and the positioning portions of the rods, the positioning elements and the elastic elements may temporarily fix a relative position between the grip and the frame. Therefore, the grip may be relatively positioned when being pulled out and being pushed back. Since the grip does not protrude out from the outline of the case of the projector, appearance integrity of the projector is maintained, and size of the projector is not increased.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A handle mechanism, adapted to a projector having a case, the handle mechanism comprising:
a frame, connected to the case, and having a pair of through holes;
a pair of rods, respectively penetrating though the through holes, capable of moving relatively to the frame, wherein each of the rods comprises a first end, a second end, an anchor portion located at the first end of the rod, a first positioning portion and a second positioning portion;
a grip, connected to the second ends of the rods, wherein the anchor portions limit a movement range of the grip relative to the frame;
a pair of positioning elements, respectively located between the frame and the rods; and
a pair of elastic elements, respectively located between the frame and the positioning elements and forcing the positioning elements to physically interfere with the first positioning portions or the second positioning portions.

2. The handle mechanism as claimed in claim 1, wherein the frame and the case are integrally formed.

3. The handle mechanism as claimed in claim 1, wherein the first positioning portions and the second positioning portions comprise fitting grooves, and the positioning elements comprise fitting flanges correspondingly fitted to the fitting grooves.

4. The handle mechanism as claimed in claim 3, wherein the first positioning portions are circularly disposed around the rods, and the second positioning portions are circularly disposed around the rods.

5. The handle mechanism as claimed in claim 1, wherein the elastic elements comprise spiral springs.

6. The handle mechanism as claimed in claim 1 further comprising:
a pair of fasteners, for fixing two ends of the grip to the second ends of the rods.

7. The handle mechanism as claimed in claim 6, wherein the fasteners comprise screws.

8. The handle mechanism as claimed in claim 6 further comprising:
a decorating sheet, attached to the grip for shielding the fasteners.

9. A handle mechanism, adapted to a projector having a case, the handle mechanism comprising:
a frame, connected to the case, and having a through hole;
a rod, penetrating through the through hole, capable of moving relatively to the frame, wherein the rod comprises a first end, a second end, an anchor portion located at the first end of the rod, a first positioning portion and a second positioning portion;
a grip, connected to the second end, wherein the anchor portion limits a movement range of the grip relative to the frame;
a positioning element, located between the frame and the rod; and
an elastic element, located between the frame and the positioning element, and forcing the positioning element to physically interfere with the first positioning portion or the second positioning portion.

10. The handle mechanism as claimed in claim 9, wherein the frame and the case are integrally formed.

11. The handle mechanism as claimed in claim 9, wherein the first positioning portion and the second positioning portion comprise fitting grooves, and the positioning element comprises a fitting flange correspondingly fitted to the fitting grooves.

12. The handle mechanism as claimed in claim 11, wherein the first positioning portion is circularly disposed around the rod, and the second positioning portion is circularly disposed around the rod.

13. The handle mechanism as claimed in claim 9, wherein the elastic element comprises a spiral spring.

14. The handle mechanism as claimed in claim 9 further comprising:
a fastener, for fixing the grip to the second end of the rod.

15. The handle mechanism as claimed in claim 14, wherein the fastener comprises a screw.

16. The handle mechanism as claimed in claim 14 further comprising:
a decorating sheet, attached to the grip for shielding the fastener.
